(19) United States
(12) Patent Application Publication
(10) Pub. No.: US 2005/0273691 A1
(43) Pub. Date: Dec. 8, 2005

(54) Metadata system for tracking quality processes

(75) Inventors: David N. Cox, Raleigh, NC (US); Gerald T. Lee, Raleigh, NC (US); Paul S. Brackett, Cary, NC (US); Paul M. Upson, Latrobe, PA (US); Ting Chien Yen, Pittsburgh, PA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: ABB Research Ltd.

(21) Appl. No.: 10/858,893

(22) Filed: Jun. 2, 2004

(51) Int. Cl. G06F 17/21

(52) U.S. Cl. 715/500; 715/505; 707/1

(57) ABSTRACT

Systems and methods for using metadata to describe quality management documents. Each quality management document is broken into sections, with each section describing the processes and checklists for a particular step in the manufacturing process. The metadata allows a system to automatically display a correctly formatted document and to guide users in the correct completion of the document. The metadata provides for error checking and condition checking to ensure the accuracy of the document.

### FIELD OF THE INVENTION

The present invention relates to quality management. In particular, the present invention is directed to a system and method of describing quality management documents and processes using metadata.

### BACKGROUND OF THE INVENTION

Quality management is the application of quality principles to facets of an organization. On any manufacturing floor, there must be policies in place to support the cost effective utilization of capacity and movement of work in progress. This is true whether the factory is building to stock or to order, whether the process is fabrication or assembly, whether execution is primarily manual or highly automated. The problem for any manufacturing organization is to select and implement the most appropriate quality management policy to meet its business goals, realizing that this policy will have to evolve over time given the progress of manufacturing technology, the continuous flow of new products, and the dynamics of the global marketplace.

One of the limitations in implementing a quality management process is that the series of steps in a manufacturing process must be followed correctly and in the proper order. Often these steps are performed manually and the failure to follow the process produces inconsistent results and, thus, poor quality. Moving from manual to automated processes helps reduce inconsistencies, but does not provide methods for automatically checking if previous steps in the process have been correctly followed. Thus, there is a need for a system that provides a method for checking the correctness of an automated process. The present invention provides such a solution.

### SUMMARY OF THE INVENTION

The present invention is directed to systems and methods for using metadata to describe quality management documents. Each quality management document is broken into sections, with each section describing the processes and checklists for a particular step in the manufacturing process. The metadata allows a system to automatically display a correctly formatted document and to guide users in the correct completion of the document. The metadata provides for error checking and condition checking to ensure the accuracy of the document.

In accordance with an aspect of the invention, there is provided a method of defining a quality management document using metadata. The method may be implemented on a computer-readable medium and includes dividing the quality management document into sections, the sections being related to a particular task to be completed; appending each section with the metadata, where the metadata describes information contained in each section; and storing each section and the metadata in a database as a metadocument.

In accordance with a feature of the invention, the method includes defining, in the metadata, a format of a form associated with the particular task. A set of rules may be defined and enforced in the forms.

In accordance with another feature, the method may include retrieving the metadocument from the database; generating an input form; receiving inputs via the input form; and merging the inputs with the metadocument. Here, the metadata defines a layout of the input form or a set of rules regarding acceptable inputs to be received by the form. The metadocument may be verified using the metadata and an action taken in accordance with a verification of the metadocument.

In accordance with another aspect of the invention, there is provided an automated system to control manufacturing processes in accordance with a quality management document. In the system there is a method of using metadata to define the quality management document that includes dividing the quality management document into sections, the sections being related to a particular task to be completed; appending each section with the metadata, where the metadata describes information contained in each section; and storing each section and the metadata in a database as a metadocument.

Additional features and advantages of the invention will be made apparent from the following detailed description of illustrative embodiments that proceeds with reference to the accompanying drawings.

### BRIEF DESCRIPTION OF THE DRAWINGS

Other features of systems and methods in accordance with the present invention are further apparent from the following detailed description of exemplary embodiments taken in conjunction with the accompanying drawings, of which:

FIG. 1 is a flow chart of the processes performed by the present invention;

FIG. 2 is a flow chart illustrating the processing of metadata; and

FIG. 3 is an exemplary computing system.

### DETAILED DESCRIPTION OF ILLUSTRATIVE EMBODIMENTS

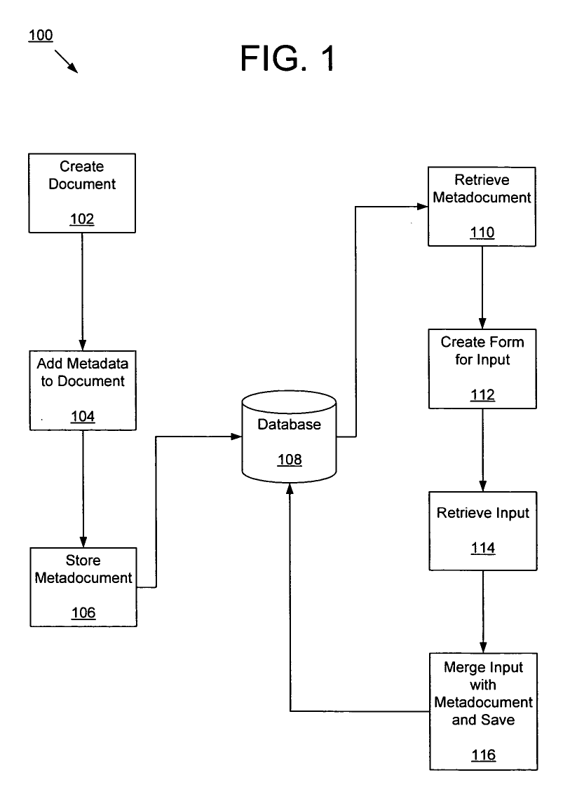

Referring to FIG. 1, there is shown an overview of the processes 100 performed by the present invention. At step 100, documents are created that detail the steps to be followed in a manufacturing process. A quality management document exists at every step in a manufacturing process. Often these are checklists that track whether an operation or test was successfully performed. In other cases the documents record test results. For example, how much did a unit weigh, or what was an output voltage of the unit?

The amount of information collected can be quite large even within a single manufacturing step. As such, the quality document is divided into sections to better organize the information. For example, a document might contain one section that is a checklist of all the operations performed. A second section might contain the test results performed on the unit at the end of that manufacturing step.

As a concrete example, the assignee of the present invention manufactures reclosers. Each recloser consists of two units known as a high voltage (HV) cabinet and a low voltage (LV) cabinet. Each high voltage cabinet consists of three pole assemblies. Each pole assembly consists of a pole and an actuator. There is a step for manufacturing actuators, another step for manufacturing poles, another for pole assemblies, another for an HV cabinet, and another for an LV cabinet. A checklist is maintained for each of these steps and test results are collected at most of them. Each checklist or list of test results represents a section in a quality document.

At step 102, metadata is added to each section of the document. The metadata describes the layout of the information and the type of information contained in each section. The metadata also describes rules controlling dependencies among the data to ensure that the steps described in the document are followed correctly and in the correct order by an automated system. Using this information the automated system can advantageously perform tasks that greatly increase the quality of the manufacturing process.

As noted above, a checklist may be one section of an overall quality document. Assume that below is a checklist used during the manufacture of reclosers:
Check open and close times
Verify CTs function properly
Check contact resistance
Volt Withstand

This checklist can be presented to the system using metadata. In this example, eXtensible Markup Language (XML) may be used to encode the checklist with metadata:

<section name=“FinalInspectionChecklist”>

<item id=“1” type=“YESNO”>

<description>Check open and close times</description>

</item>
<item id=“2” type=“YESNO”>

<description>Verify CTs function properly</description>

</item>
<item id=“3” type=“YESNO”>

<description>Check contact resistance</description>

</item>
<item id=“4” type=“NUMBER”>

<description>Volt Withstand</description>

</item>

</section>

In addition to displaying the descriptions of each checklist item, the XML code can be used to enforce how the user must answer each item. In the checklist above, the first three items the user must answer either YES or NO. For item 4 the user must provide a number. Using this information the computer can automatically construct a user interface for a form to collect this information.

Dependency information can be included in the checklist. For example, the processing may be such that the contact resistance should be checked only if the CTs are functioning properly. In other words, if the CT's are not functioning properly, then the contact resistance should not be checked. As such, item 3 can be modified as follows:

<item id=“3” type=“YESNO”>

<description>Check contact resistance</description>
<precondition itemid=“2” value=“YES” />

</item>

Here the metadata is supplemented with a precondition that determines if the system will collect information for item 3. If the value collected for item 2 is YES, then the system will collect the information for item 3. If the value for item 2 is NO, then the system will not allow the user to enter information for item 3.

As a further example, item 3 can be supplemented further:

<item id=“3” type=“YESNO”>

<description>Check contact resistance</description>
<precondition itemid=“2” value=“YES” />
<do value=“YES” action=“A1” />
<do value=“NO” action=“A2” />

</item>

In this case the system can take one action if the value of item 3 is YES and another action if the value is NO. The strings used for actions (A1 and A2 in this case) have a meaning to the system. For example, A1 could mean that the system will perform some manufacturing operation itself, while A2 could mean that the system will send a message to a manager or sound an alarm.

Returning to FIG. 1, at step 106, the metadata sections are then stored in a database 108 as a metadocument.

During manufacturing, the appropriate section of the metadocument for a process is retrieved (step 110). The section may include forms or checklists. According to an advantageous aspect of the invention, the metadata provides for formatting of the form or checklist associated with a particular part of the process (step 112). The system examines the metadata for an item and retrieves the description of an item, the type item (e.g., YESNO, NUMBER, STRING), and can automatically prompt the user to enter the information. If it is a YESNO answer, the system may display a checkbox. If it is a NUMBER or STRING, the system displays an edit box. It is also possible to specify a list of valid answers. In this case the system provides a list in a listbox allowing the user to choose one. The system can use this metadata to validate what the user entered. If the item type is NUMBER, the computer can ensure that the user entered a number, etc. Doing this for each item allows the system to construct an entire form. This prevents many of the entry errors noted above.

After the system has presented the form, the user can complete it by entering data at step 114. As the user completes each item and moves to the next item, the system will retrieve the user input and perform whatever actions are required. Each item is part of a section and each section is part of an overall quality document. As the user completes each item, the computer retrieves the input and merges it with the rest of the document at step 116. The entire document (i.e., all the items along with the data the user provided) is then saved to the database 108.

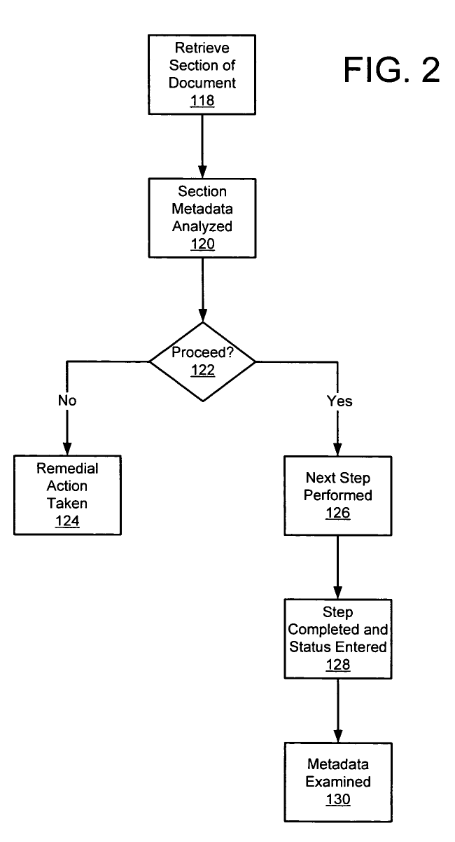

Referring to FIG. 2, there is illustrated an overview of the processes performed at steps 110-114 in greater detail. It is noted that these steps may be performed in a system that is fully automated (i.e., a computer performs all steps) or semi-automated (i.e., the computer performs the analysis; however, a user performs other steps). When the document is retrieved at step 118, the section data is analyzed by the system at step 120. The analysis confirms that steps and processes have been performed correctly and in the correct order. At step 122, it is determined if the processing should continue based on the result of the analysis.

Conventionally, forms and checklists are created using a word processor and they are later printed and filled in by hand, or the forms are available online such that a person can fill them out electronically. Although the form is stored electronically (e.g., as a Word document or Excel spreadsheet), its free formatted nature and lack of standardization make it nearly impossible for a computer to analyze it. In accordance with the present invention, at step 122, the system can perform an analysis of the metadata and prevent someone from filling in checklist items or test results if it determines that doing so would be out of sequence (e.g., a component cannot be tested if it has not been fully assembled). Thus, if a user tried to record test results without checking off all the items in the checklist, the system would identify the error condition.

As an additional example, the system may send e-mail messages if it determines that something is wrong in the manufacturing process. For example, if a unit's voltage is too high, a message could be sent to an engineer indicating a potential problem in the manufacturing process. Yet another example is if the system rather than a person performs all the operations. The computer fills out the checklists and test results and then decides using these results if it should continue to the next step. This would be in a situation where the manufacturing process is fully automated.

If there is a problem at step 122, remedial action may be taken at step 124 so the processing can proceed. If, at step 122, the system determines the processing should proceed, the next step is performed at step 126, and a status is entered at step 128 after the step is completed. At step 130, the metadata examined and user input may be accepted.

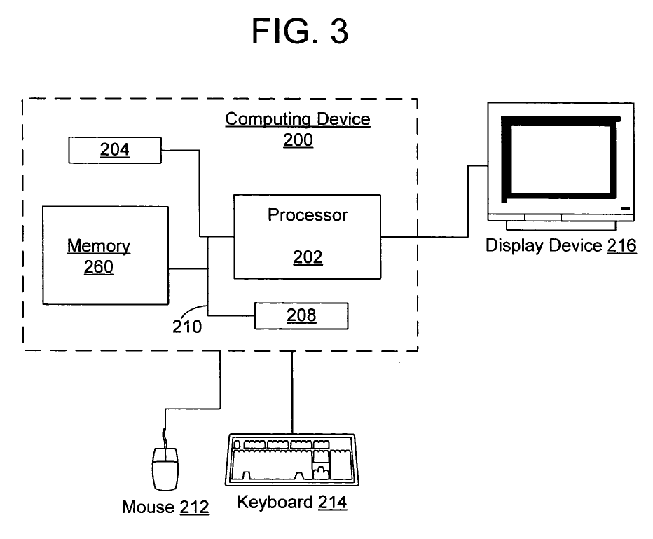

FIG. 3 is a diagram of a generic computing device, which may be operable to perform the steps described above. As shown in FIG. 3, the system computing device 200 includes processor 202, system memory 206, and system bus 210 that couples various system components including system memory 206 to processor 202. System memory 206 may include read-only memory (ROM) and/or random access memory (RAM). Computing device 200 may further include hard-drive 208, which provides storage for computer readable instructions, data structures, program modules, data, and the like. A user (not shown) may enter commands and information into the computing device 200 through input devices such as keyboard 214 or mouse 212. A display device 216, such as a monitor, a flat panel display, or the like is also connected to computing device 200. Communications device 204, which may be a modem, network interface card, or the like, provides for communications over a network. System memory 206 and/or hard-drive 208 may be loaded with any one of several computer operating systems such as WINDOWS XP or WINDOWS SERVER 2003 operating systems, LINUX operating system, and the like.

The invention is software that would be either a standalone program or a module that could be used from within another program. The software could be implemented using any general purpose programming language such as C++, Visual Basic, C#, etc. Any programming language that can produce a standalone program or module would be appropriate.

While systems and methods have been described and illustrated with reference to specific embodiments, those skilled in the art will recognize that modification and variations may be made without departing from the principles described above and set forth in the following claims. Accordingly, reference should be made to the following claims as describing the scope of disclosed embodiments.

1. A method of defining a quality management document using metadata, comprising:
dividing said quality management document into sections, said sections being related to a particular task to be completed;
appending each section with said metadata, where said metadata describes information contained in each section; and
storing said each section and said metadata in a database as a metadocument.

2. The method of claim 1, further comprising defining, in said metadata, a format of a form associated with said particular task.

3. The method of claim 2, further comprising defining a set of rules to be enforced in said forms.

4. The method of claim 1, further comprising:
retrieving said metadocument from said database;
generating an input form;
receiving inputs via said input form; and
merging said inputs with said metadocument.

5. The method of claim 4, wherein said metadata defines a layout of said input form.

6. The method of claim 5, wherein said metadata defines a set of rules regarding acceptable inputs to be received by said form.

7. The method of claim 4, further comprising verifying said metadocument using said metadata.

8. The method of claim 7, wherein an action is taken in accordance with a verification of said metadocument.

9. In an automated system to control manufacturing processes in accordance with a quality management document, a method of using metadata to define said quality management document, comprising:
dividing said quality management document into sections, said sections being related to a particular task to be completed;
appending each section with said metadata, where said metadata describes information contained in each section; and
storing said each section and said metadata in a database as a metadocument.

10. The method of claim 9, further comprising defining, in said metadata, a format of a form associated with said particular task.

11. The method of claim 10, further comprising defining a set of rules to be enforced in said forms.

12. The method of claim 11, wherein an action is taken by said automated system in accordance with a verification of said metadata.

13. A computer-readable medium having computer-executable instructions for instructing a multimedia device to perform the steps of:
dividing said quality management document into sections, said sections being related to a particular task to be completed;
appending each section with said metadata, where said metadata describes information contained in each section; and
storing said each section and said metadata in a database as a metadocument.

14. The computer-readable medium of claim 13, further comprising instructions for defining, in said metadata, a format of a form associated with said particular task.

15. The computer-readable medium of claim 14, further comprising instructions for defining a set of rules to be enforced in said forms.

16. The computer-readable medium of claim 13, further comprising instructions for:
retrieving said metadocument from said database;
generating an input form;
receiving inputs via said input form; and
merging said inputs with said metadocument.

17. The computer-readable medium of claim 16, wherein said metadata defines a layout of said input form.

18. The computer-readable medium of claim 17, wherein said metadata defines a set of rules regarding acceptable inputs to be received by said form.

19. The computer-readable medium of claim 16, further comprising instructions for verifying said metadocument using said metadata.

20. The computer-readable medium of claim 19, wherein an action is taken in accordance with a verification of said metadocument.
